(19) United States
(12) Patent Application Publication
(10) Pub. No.: US 2014/0297547 A1
(43) Pub. Date: Oct. 2, 2014

(54) SOCIAL NETWORK RECRUITING ALERTS

(71) Applicant: Empire Technology Development LLC, Wilmington, DE (US)

(72) Inventor: Ezekiel Kruglick, Poway, CA (US)

(21) Appl. No.: 13/643,041

(22) PCT Filed: Jul. 3, 2012
(86) PCT No.: PCT/US12/45432

§ 371 Date: Oct. 23, 2012

(51) Int. Cl. G06Q 50/00; G06Q 10/10

(52) U.S. Cl. CPC G06Q 50/01; G06Q 10/1053
USPC 705/319

(57) ABSTRACT

Technologies related to social network recruiting alerts are generally described. Passive recruiting targets may be registered, and a set of contacts linked to the passive recruiting target in a social network graph may be monitored. Recruiting alerts may be generated in response to changes in social network profile data associated with the set of contacts.

### BACKGROUND

Unless otherwise indicated herein, the materials described in this section are not prior art to the claims in this application and are not admitted to be prior art by inclusion in this section.

Social network technologies are rapidly evolving, led by companies such as FACEBOOK® and LINKEDIN®. In general, these and other social networks allow participants to create profiles including a variety of social network profile data, and to connect to other participants to share data and interact in a variety of ways.

Because social networks receive and store digital data from potentially large numbers of participants, social networks are well positioned to offer services involving the use of such data in novel, interesting and beneficial ways. One example is employee recruiting. LINKEDIN® offers recruiting services which allow recruiters to search for candidates, store identified candidates, and view stored candidates via web-based User Interfaces (UI). As these and other social network technologies continue to evolve, it is expected that available tools will become more powerful and effective, for the benefit of social network operators, participants, and third parties such as recruiters and advertisers.

### SUMMARY

The present disclosure generally describes technologies including devices, methods, and computer readable media relating to social network recruiting alerts. Some example methods may comprise social network methods for providing recruiting alerts, comprising registering a passive recruiting target; identifying a set of contacts linked to the passive recruiting target in a social network graph; electronically monitoring social network profile data associated with the set of contacts; and/or automatically generating a recruiting alert identifying the passive recruiting target in response to an event comprising a change in social network profile data associated with the set of contacts. Recruiting alerts may be effective to reclassify the passive recruiting target as an active recruiting target.

For example, the set of contacts may comprise contacts that have social network profile data indicating employment by a same employer as the passive recruiting target, and the event may comprise a change in employer information. Social network profile data associated with the passive recruiting target may also be monitored, and recruiting alerts may also be generated in response to changes therein.

Social network methods for providing recruiting alerts may comprise providing an electronic recruiting alert service to a third party, comprising receiving an identification of the passive recruiting target from a remote third-party computing device; registering the passive recruiting target in the electronic recruiting alert system in response to such receiving; and sending, by the electronic recruiting alert system, the recruiting alert identifying the passive recruiting target to the remote third-party computing device.

Social network methods for providing recruiting alerts may also include providing passive recruiting information to the passive recruiting target, for example, providing a notification that the passive recruiting target is being monitored by one or more recruiters. Communications between the passive recruiting target and a recruiter may optionally be mediated in response to passive recruiting target requests for recruiter information.

Social network methods for providing recruiting alerts may also include conducting online recruiting alert auctions, and providing recruiting alerts according to auction results. For example, methods may include first providing the recruiting alert to a first priority recruiter, and second providing, after at least a predetermined time interval, the recruiting alert to a second priority recruiter, wherein the first priority recruiter, second priority recruiter and so forth may be established via an online recruiting alert auction.

Some example methods may comprise recruiter methods for accessing social network recruiting alerts, comprising receiving an identification of the passive recruiting target; registering the passive recruiting target in a remote electronic recruiting alert system, wherein registering the passive recruiting target comprises sending information identifying the passive recruiting target to an electronic recruiting alert system network interface; providing event monitoring data to the remote electronic recruiting alert system, wherein the event monitoring data specifies monitoring of events comprising changes in social network profile data associated with one or more contacts in a set of contacts linked to the passive recruiting target in a social network graph; receiving a recruiting alert identifying the passive recruiting target and indicating that an event according to the event monitoring data occurred; and/or reclassifying the passive recruiting target as an active recruiting target in response to the recruiting alert.

For example, as noted above, the set of contacts may comprise contacts that have social network profile data indicating employment by a same employer as the passive recruiting target, and the event monitoring data may specify monitoring of events comprising changes of employer information. The event monitoring data may also optionally specify monitoring of events comprising changes in social network profile data associated with the passive recruiting target.

Recruiter methods for accessing social network recruiting alerts may also include providing passive recruiting information permission to the remote electronic recruiting alert system to permit the remote electronic recruiting alert system to provide passive recruiting information, such as a notification that the passive recruiting target is being monitored by one or more recruiters, to the passive recruiting target. The passive recruiting target may be reclassified as an active recruiting target in response to a passive recruiting target request for information.

Some example methods may comprise recruiting alert auction methods, comprising electronically monitoring one or more of social network profile data associated with the passive recruiting target, and social network profile data associated with contacts in a set of contacts linked to the passive recruiting target, in a social network graph; receiving an identification of a first priority recruiter established via an online recruiting alert auction; and/or automatically providing a recruiting alert identifying the passive recruiting target to the first priority recruiter in response to an event comprising a change in monitored social network profile data. Some embodiments may furthermore comprise automatically providing, after at least a predetermined time interval, the recruiting alert to a second priority recruiter established via the online recruiting alert auction.

For example, in recruiting alert auction methods, the set of contacts may comprise contacts that have social network profile data indicating employment by a same employer as the passive recruiting target, and the event may comprise a change in employer information in social network profile data associated with the set of contacts. In some example recruiting alert auction methods, the event comprising a change in monitored social network profile data may comprise, e.g., a threshold number of changes in the social network profile data associated with the passive recruiting target, each of the threshold number of changes occurring within a time window of predetermined length; an event comprising a change of family status in the social network profile data associated with the passive recruiting target; and/or an event comprising a change of address in the social network profile data associated with the passive recruiting target.

Computing devices and computer readable media having instructions implementing the various technologies described herein are also disclosed. Example computer readable media may comprise non-transitory computer readable storage media having computer executable instructions executable by a processor, the instructions that, when executed by the processor, cause the processor to carry out any combination of the various methods provided herein. Example computing devices may include a processor, a memory, and an electronic recruiting alert system, recruiter system, and/or other systems, applications and tools configured to carry out the methods described herein.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a block diagram illustrating an example social network device configured to provide recruiting alerts;

FIG. 2 is a block diagram of a computing device as one example of a social network device;

FIG. 3 is a block diagram illustrating an example social network device configured to provide recruiting alert auctions;

FIG. 4 is a flow diagram illustrating an example social network method configured to provide recruiting alerts;

FIG. 5 is a block diagram illustrating an example recruiter device configured to access social network recruiting alerts; and

FIG. 6 is a flow diagram illustrating an example recruiter method for accessing social network recruiting alerts;

all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and made part of this disclosure.

The present disclosure is generally drawn, inter alia, to technologies including methods, devices, systems and/or computer readable media deployed therein relating to social network recruiting alerts. Passive recruiting targets may be registered, and a set of contacts linked to the passive recruiting target in a social network graph may be monitored. Recruiting alerts may be generated in response to changes in social network profile data associated with the set of contacts.

Recruiting is moving beyond the classic “call for resumes” scenario, in which a position is advertized, applicants submit their resumes, and a recruiter then reviews the resumes, interviews and hires a top candidate. Resume information is now often available and may be continuously updated online, via social networks, especially professional-oriented social networks such as LINKEDIN®, XING®, and VIADEO®. Social networks can provide valuable recruiting information including, for example, skills and experience of recruiting targets. As a result, recruiters can now find “passive” recruiting targets in advance, and then wait for an opportunity to actively recruit them.

The terms “passive recruiting target” and “active recruiting target” as used herein presume two or more levels of recruiting activity. A passive recruiting target is one who, for any reason, may be subject to a lower level of recruiting activity than an active recruiting target. For example, in some scenarios, passive recruiting targets may not be contacted by the recruiter, while active recruiting targets are contacted. Alternatively, passive recruiting targets may be contacted in a “less active” manner, while active recruiting targets may be contacted in a “more active” manner. A written letter or email is generally considered a less active mode of contact, while multiple written letters or emails is more active, telephone calls are again more active, and in-person visits are again more active. In some cases, Human Resource (HR) software and/or recruiting software may classify recruiting targets as passive or active targets, resulting in different levels of human or automated recruiting activity directed at a recruiting target.

This disclosure appreciates that it may be difficult for the recruiter to know when recruiting targets should be classified as “passive” or “active”. Any number of criteria might be used to classify recruiting targets. In some cases, individuals may indicate in their social network profiles that they are open to contact about new opportunities and/or actively seeking a new position and this information may be used to classify recruiting targets. However, individuals may not always indicate in their social network profile that they are open to contact about new opportunities and/or actively seeking a new position, especially if they do not want their current employer and/or coworkers to have such information. The recruiter may not want to annoy the disinterested passive recruiting target or waste unnecessary recruiting resources on a disinterested passive recruiting target, while conversely, the recruiter appreciates that, in competitive job markets, the sooner the passive recruiting target can be accurately identified as an active recruiting target, the better.

This disclosure appreciates that valuable recruiting information can extend beyond skills and experience information that may be present in social network profile data of the passive recruiting target, to social network profile data that indicates likelihood that the passive recruiting target will be receptive to recruiting activities.

For example, relationships with co-workers can provide a consistent predictor of employee retention, and conversely, provide an indicator of when employees may be ready for a change. Job dissatisfaction is presently the driving force in fewer than half of individual turnover decisions. Instead, the typical turnover process includes first a generalized disengagement, which can be caused by the departure of co-worker friends, and then a “shock” such as an unexpected job offer or the departure of a specific co-worker. This is called the unfolding model. Co-worker departures may provide both a setup and shock in some scenarios, and a job offer shortly after a co-worker departure not only fulfills the unfolding model narrative but also takes advantage of social proof as the co-worker has just demonstrated the validity of turnover and finding a new job. As a result, social network profile data of contacts of the passive recruiting target and employer information of coworkers of the passive recruiting target in particular may in some instances provide valuable recruiting information.

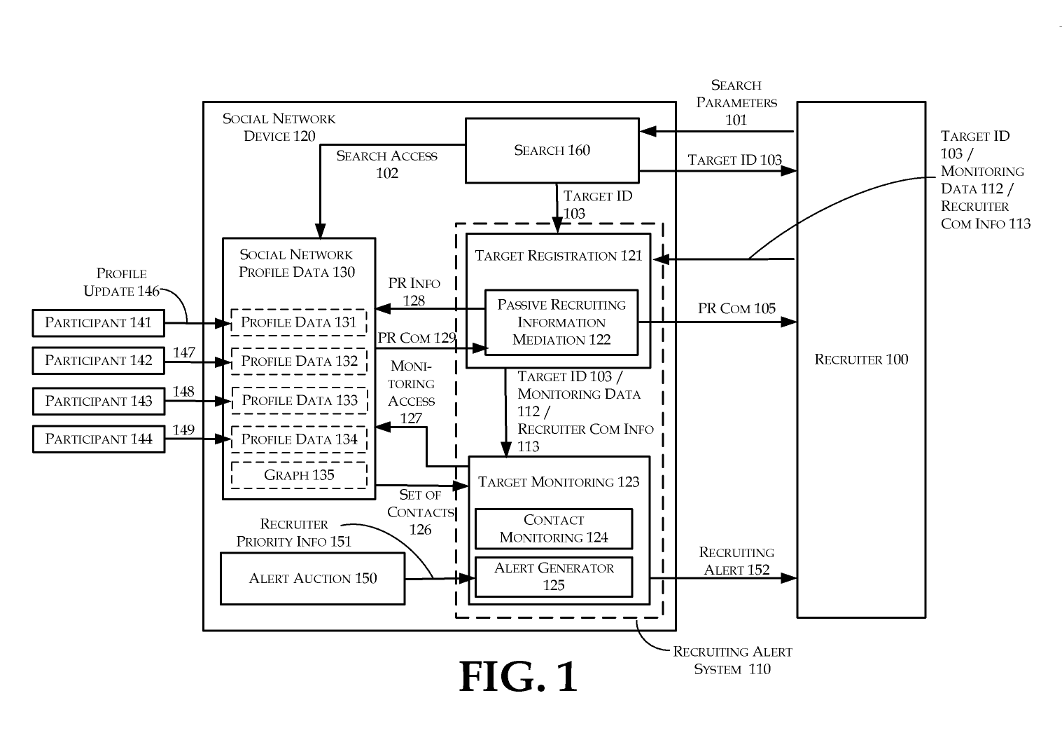

FIG. 1 is a block diagram illustrating an example social network device configured to provide recruiting alerts, arranged in accordance with at least some embodiments of the present disclosure. FIG. 1 includes a recruiter 100, a social network device 120, and participants 141, 142, 143, and 144. Any of participants 141, 142, 143, and 144 may comprise a passive recruiting target. Social network device 120 includes a search component 160, an electronic recruiting alert system 110, social network profile data 130, and an alert auction component 150. Electronic recruiting alert system 110 comprises a target registration component 121 and a target monitoring component 123. Target registration component 121 includes a passive recruiting information mediation component 122. Target monitoring component 123 includes a contact monitoring component 124 and an alert generator component 125. Social network profile data 130 includes profile data 131, 132, 133, and 134, and a social network graph 135.

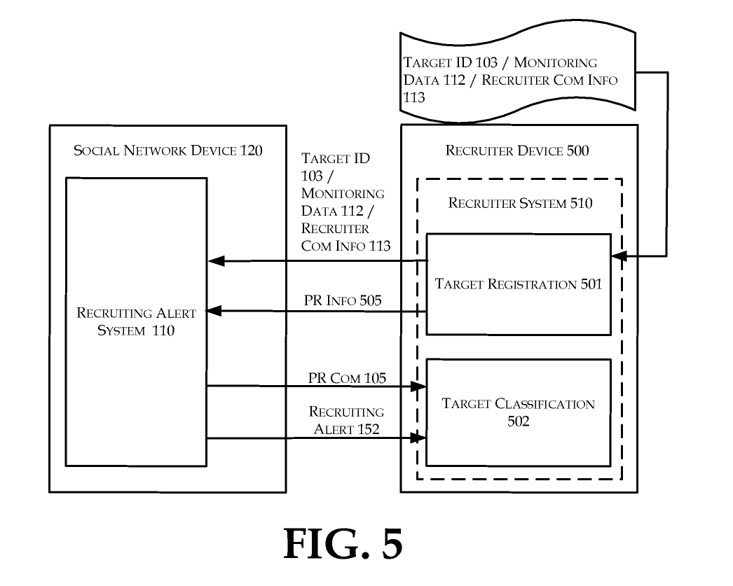

In FIG. 1, recruiter 100 may comprise a human operator of a computing device, such as a general purpose laptop, desktop, mobile device and/or tablet device equipped with a browser to connect to a website supported by social network device 120. Social network device 120 may comprise one or more devices operated by a social network operator to implement a social network, and configured to support social network methods for providing recruiting alerts described herein. In some embodiments, social network device 120 may be configured for automated interactions with recruiter 100 and/or with a recruiting services provider device positioned between recruiter 100 and social network device 120, as discussed further herein in connection with FIG. 5. Participants 141-144 may comprise participants in the social network supported by social network device 120. In general, recruiter 100 may access social network device 120 to perform searches to identify passive recruiting targets. Recruiter 100 may access social network device 120 to register passive recruiting targets for monitoring. Social network device 120 may be configured to monitor registered passive recruiting targets, as well as contacts of registered passive recruiting targets, and to generate recruiting alerts in response to occurrence of certain events. For example, social network device 120 may be configured to generate recruiting alerts in response to employer changes in profile data associated with contacts of registered passive recruiting targets.

In some embodiments, recruiter 100, social network device 120, and participants 141-144 may be connected by via a network such as the Internet. The various communications illustrated between recruiter 100, social network device 120, and participants 141-144 may be transmitted via the network connection. Social network device 120 may be configured to provide web pages comprising UI accessible by recruiter 100 via the network, the UI comprising fields and controls configured to support recruiter 100 interactions with search component 160, recruiter alert system 110, and/or alert auction component 150. By including recruiter alert system 110, social network device 120 may be configured to provide an electronic recruiting alert service to a third party such as recruiter 100. The electronic recruiting alert service may be configured for operations comprising receiving, at the electronic recruiting alert system 110, an identification of the passive recruiting target such as a target ID 103 from a remote third-party computing device operated by recruiter 100; registering the passive recruiting target in the electronic recruiting alert system 110 in response to receiving target ID 103; and sending, by the electronic recruiting alert system 110, a recruiting alert 152 identifying the passive recruiting target and/or recruiting event to the remote third-party computing device operated by recruiter 100.

Social network device 120 may also be configured to provide web pages comprising UI accessible by participants 141-144 to support participant interactions with their respective profile data 131-134, including for example participant profile updates 146-149 to profile data 131-134, respectively, participant connections with other participants which may be mapped in social network graph 135, and participant communications with one another which may stored as part of profile data 131-134 according to any desired privacy model, and any other participant interactions in the social network. The various communications illustrated between components inside social network device 120 may be implemented as interactions between components within a single or multiple devices implementing social network device 120.

Recruiter 100 may provide recruiter search parameters 101 to search component 160. Recruiter search parameters 101 may include, for example, candidate qualification parameters such as education parameters, work experience parameters, skills parameters, and any number of other parameters as may be useful for recruiting. Search component 160 may be configured to provide search UI, comprising fields configured to receive search parameters 101, and a search initiation control configured to receive a recruiter search initiation command. Search component 160 may be configured to conduct a search of social network profile data 130 according to received search parameters 101, in response to the received recruiter search initiation command. Search component 160 may be configured to make search access 102 to social network profile data 130, including any indexes into social network profile data 130, to execute recruiter searches. Search component 160 may thereby obtain search results comprising identifiers of participants that match received search parameters 101.

Search component 160 may be configured to provide the search results in a search result UI accessible by recruiter 100. In some embodiments, the search result UI may be configured to receive recruiter selections of passive recruiting targets, and to provide selected target IDs, such as target ID 103, to target registration component 121. In some embodiments, target ID 103 may be recorded by recruiter 100 and provided to target registration component 121 pursuant to an interaction between recruiter 100 and target registration component 121.

Target registration component 121 may be configured to provide target registration UI configured to allow recruiter 100 to register passive recruiting targets for monitoring. Target registration UI may comprise fields configured to receive target ID 103, monitoring data 112, and/or recruiter communication information 113, and a monitoring initiation control. In some embodiments, target registration component 121 may be configured to provide one or more recruiter account setup UI, and monitoring data 112 and recruiter communication information 113 may optionally be received by the recruiter account setup UI, for use with all target IDs registered by recruiter 100. Target registration component 121 may be configured to initiate target monitoring for the passive recruiting target identified by target ID 103, wherein target monitoring is performed according to monitoring data 112, in response to recruiter activation of the monitoring initiation control. Recruiter communication information 113 may comprise, e.g., an email address, network Application Programming Interface (API) address, or other communication information for use in sending recruiting alerts to recruiter 100. Target registration component 121 may be configured to provide recruiter communication information 113, along with target ID 103 and/or monitoring data 112, to target monitoring component 123 to initiate target monitoring.

Monitoring data 112 may comprise identifications of data within social network profile data 130 to be monitored by target monitoring component 123. In some embodiments, monitoring data 112 may be pre-determined by the social network operator, and may not be customized by recruiter 100. Otherwise, recruiting alert system 110 may be configured to provide recruiter 100 an opportunity to select or otherwise provide custom monitoring data. Target registration UI may for example comprise fields configured to receive monitoring data 112 selections.

Target registration component 121 and target monitoring component 123 may be configured to support any desired monitoring data 112 selections. Monitoring data 112 may include social network profile data associated with the registered passive recruiting target, e.g., the participant identified by target ID 103, and/or social network profile data associated with a set of contacts linked to the registered passive recruiting target in social network graph 135.

Monitoring data 112 from social network profile data associated with the passive recruiting target may comprise, for example, passive recruiting target status updates and/or occurrence of specific language therein, passive recruiting target contacts and/or occurrence of specific contacts therein, passive recruiting target physical address and/or occurrence of specific locations therein, passive recruiting target email address, telephone number or other communication information, passive recruiting target relationship status and/or occurrence of specific status types therein, passive recruiting target family information and/or occurrence of specific types of family information therein, passive recruiting target employer information and/or occurrence of specific employer information therein, passive recruiting target title or position information and/or occurrence of specific language therein, passive recruiting target job description and/or occurrence of specific language therein, passive recruiting target resume or work history information and/or occurrence of specific language therein, passive recruiting target communications data such as email and text message data and/or occurrence of specific language therein, passive recruiting target recommendations and/or occurrence of specific language therein, and/or or any other social network profile data associated with the passive recruiting target.

Monitoring data 112 from social network profile data associated with the set of contacts linked to the registered passive recruiting target in social network graph 135 may comprise, for example, contact employer information and/or occurrence of specific language therein, contact title or position information and/or occurrence of specific language therein, as well as optionally any of the monitoring data 112 set forth above for the passive recruiting target, including, for example, contact status updates and/or occurrence of specific language therein, contacts of a contact and/or occurrence of specific contacts therein, contact physical address and/or occurrence of specific locations therein, contact email address, telephone number or other communication information, contact relationship status and/or occurrence of specific status types therein, contact family information and/or occurrence of specific types of family information therein, contact job description and/or occurrence of specific language therein, contact resume or work history information and/or occurrence of specific language therein, contact communications data such as email and text message data and/or occurrence of specific language therein, contact recommendations and/or occurrence of specific language therein, and/or or any other social network profile data associated with a contact.

Monitoring data 112 may also comprise data specifying which contacts to include in the set of contacts. For example, monitoring data 112 may specify a set of contacts comprising contacts that have social network profile data indicating employment by a same employer as the passive recruiting target, contacts having a same job description or title as the passive recruiting target, contacts who have recommended passive recruiting target, contacts who have one or more same group affiliations as passive recruiting target, contacts who have exchanged one or more private messages with the passive recruiting target, or any combination of such contact attributes. Monitoring data 112 may specify a set of contacts comprising contacts directly linked to the passive recruiting target in the social network graph 135, or may include indirectly linked contacts such as contacts that are one or two steps away from the passive recruiting target. Direct or indirect linkage properties may also be specified by monitoring data 112 in combination with the other contact attributes described above.

Monitoring data 112 may also comprise any desired combination of the monitoring data 112 enumerated herein. For example, monitoring data 112 may specify monitoring contact employer information for any change in combination with passive recruiting target status updates for certain specific language. In another example, monitoring data 112 may specify monitoring passive recruiting target status updates for certain specific language in combination with certain specific locations in the passive recruiting target physical address. In either of the above examples, detection of both conditions may comprise an event for which an alert is generated, while detection of just one of the conditions may not comprise an event for which an alert is generated.

In some embodiments, monitoring data 112 may specify one or more social network profile data type(s), e.g., passive recruiting target contacts and/or passive recruiting target physical address, and target monitoring component 123 may be configured to monitor specified data type(s) for any change, and to generate a recruiting alert in response to any change in the specified data type. In some embodiments, monitoring data 112 may specify specific language or other information for the social network profile data type, e.g., the presence of the word “San Francisco” in a contact physical address field and/or in the passive recruiting target physical address, and target monitoring component 123 may be configured to monitor the specified data type for the specific language or other information, and to generate a recruiting alert in response to changes including the specified specific language or other information.

Target monitoring component 123 may be configured to receive target ID 103, and optionally monitoring data 112 and/or recruiter communication information 113, from target registration component 121, and to initiate monitoring in response to activation by target registration component 121. In some embodiments, target monitoring component 123 may be configured to perform monitoring by monitoring access 127 to social network profile data 130.

In some embodiments, monitoring access 127 may comprise a series of monitoring accesses to social network profile data associated with the passive recruiting target identified by target ID 103. Monitoring accesses may be performed at any desired interval, e.g., anywhere from per minute to per day or per week. Monitoring accesses may read social network profile data specified by monitoring data 112 to detect whether any social network profile data specified in monitoring data 112 is present, or changed, as indicated in monitoring data 112. This is referred to herein as a “recruiting event”. Recruiting events involving social network profile data associated with the passive recruiting target may include, for example, a change of family status in the social network profile data associated with the passive recruiting target, a change of address in the social network profile data associated with the passive recruiting target, and/or a threshold number of changes, such as three to ten changes, or any other threshold number of changes, in the social network profile data associated with the passive recruiting target, each of the threshold number of changes occurring within a time window of predetermined length, such as a time window of one day to one week, or any other time window length. Target monitoring component 123 may be configured to use alert generator component 125 to automatically generate recruiting alerts identifying the passive recruiting target in response to occurrence of recruiting events.

In some embodiments, target monitoring component 123 may comprise contact monitoring component 124. Contact monitoring component 124 may be configured to identify a set of contacts 126 linked to the passive recruiting target in social network graph 135, and optionally meeting any other criteria as may be specified for set of contacts 126 in monitoring data 112. For example, when monitoring data 112 specifies a set of contacts that have social network profile data indicating employment by a same employer as the passive recruiting target, and that are also directly linked to the passive recruiting target in social network graph 135, contact monitoring component 124 may be configured to identify set of contacts 126 by determining all contacts directly linked to the passive recruiting target in social network graph 135, and accessing social network profile data 130 to identify a subset of contacts having social network profile data indicating employment by a same employer as the passive recruiting target.

Contact monitoring component 124 may be configured to electronically monitor social network profile data associated with contacts in set of contacts 126, to detect recruiting events, by monitoring access 127 to social network profile data 130, as described above. Contact monitoring component 124 may be configured to use alert generator component 125 to automatically generate recruiting alerts identifying the passive recruiting target in response to recruiting events involving set of contacts 126. For example, contact monitoring component 124 may be configured to automatically generate a recruiting alert in response to a recruiting event comprising a change in employer information, address, or title in social network profile data associated with one or more of the contacts in set of contacts 126.

Contact monitoring component 124 may be configured to use alert generator component 125 for example by initiating alert generator component 125 when a recruiting event is detected. Contact monitoring component 124 may be configured to provide target ID 103 for the passive recruiting target to alert generator component 125 when a recruiting event is detected for the passive recruiting target. Contact monitoring component 124 may also be configured to provide recruiter communication information 113 to alert generator component 125, or alternatively, alert generator component 125 may be configured to look up recruiter communication information 113 for a recruiter corresponding to a detected recruiting event. In some embodiments, alert generator component 125 may be configured to place a recruiting alert 152 in an alert UI or recruiter messaging UI accessible by recruiter 100 via recruiter 100 access to the website provided by social network device 120. Alert generator component 125 may be configured to reclassify the passive recruiting target, such that the passive recruiting target is reclassified as an active recruiting target. For example, alert generator component 125 may be configured to place target ID 103 among a list, table, service API message, or other data structure comprising active recruiting targets, wherein the active recruiting targets data structure is available to recruiter 110 via a UI provided by the recruiting alert system 110 or otherwise.

In some embodiments, alert generator component 125 may be configured to generate and send an email, text message, network API communication, or other electronic communication, comprising recruiting alert 152, to a recruiter email address, telephone number, and/or network API identified in recruiter communication information 113. Recruiting alert 152 may comprise target ID 103, along with an indication that a recruiting event has occurred. Recruiting alert 152 may comprise any level of detail, as desired in view of participant privacy considerations, regarding specific information involved in the recruiting event.

In some embodiments, alert generator component 125 may be configured to provide recruiting alert 152 to a plurality of recruiters, e.g., to all recruiters monitoring the passive recruiting target for the recruiting event(s) involved in the recruiting alert 152. Alert generator component 125 may be configured to provide recruiting alert 152 to the plurality of recruiters substantially simultaneously, e.g. within seconds to minutes of each other, or alternatively, serially according to relative priority of the various recruiters, with at least a predetermined time interval, such as one or more days to one or more weeks, between recruiters at different priority levels. For example, some recruiters may pay for priority recruiting alerts, and may receive recruiting alerts substantially immediately. Recruiters receiving second-priority recruiting alerts may receive recruiting alerts days or weeks after occurrence of a recruiting event.

In some embodiments, recruiter priority levels may be established via an online recruiting alert auction, which may be conducted by alert auction component 150, as described herein. Alert auction component 150 may provide recruiter priority information 151 to alert generator component 125, and alert generator component 125 may send recruiting alert 152 to first priority, second priority, and any other recruiters, in serial fashion according to recruiter priority information 151.

In some embodiments, target registration component 121 may comprise passive recruiting information mediation component 122. Passive recruiting information mediation component 122 may be configured to mediate sharing passive recruiting information between recruiter 100 and the passive recruiting target. Passive recruiting information mediation component 122 may be configured to provide passive recruiting information 128 to the passive recruiting target via a social network communications channel, e.g., by providing information to profile data 130. For example, passive recruiting information 128 may comprise a social network-hosted email or other private communication for participant 141, wherein participant 141 is the passive recruiting target. Alternatively, passive recruiting information 128 may comprise a public comment to the passive recruiting target's profile 131.

Passive recruiting information 128 may indicate that the passive recruiting target has been identified as a passive recruiting target. Passive recruiting information 128 may optionally comprise a notification that the passive recruiting target is being monitored by one or more recruiters, and furthermore, may optionally include some or all of the monitoring data 112 that is monitored. Passive recruiting information 128 may optionally also include any additional information, such as an identification of recruiter 100, a link configured to enable the passive recruiting target request to request recruiter information, a link configured to anonymously request identification of recruiter 100, and/or a link to notify recruiter 100 that the passive recruiting target is open to being contacted by recruiter 100, whether or not recruiter 100 is identified. In response to selection of a link provided in passive recruiting information 128, a passive recruiting communication 129 may be returned to passive recruiting information mediation component 122 and/or to alert generator component 125 (not shown in FIG. 1).

Passive recruiting information mediation component 122 may be configured to mediate a communication between the passive recruiting target and recruiter 100 in response to passive recruiting communication 129. Passive recruiting information mediation component 122 may be configured to notify recruiter 100, e.g., by forwarding passive recruiting communication 129 to recruiter 100 as passive recruiting communication 105, wherein passive recruiting communication 105 may or may not include all information associated with passive recruiting communication 129. Passive recruiting information mediation component 122 may optionally be configured to remove information from passive recruiting communication 129 when generating passive recruiting communication 105, e.g., to protect the passive recruiting target's privacy or to allow the passive recruiting target to remain anonymous. Alert generator component 125 may optionally be configured to generate recruiting alert 152 in response to receiving passive recruiting communication 129.

Social network device 120, search component 160, electronic recruiting alert system 110, social network profile data 130 and alert auction component 150 may be arranged in a wide variety of ways and according to a variety of programming techniques, and this disclosure is not limited to the arrangement and interactions between the various components illustrated in FIG. 1. For example, electronic recruiting alert system 110 may include any arrangement of target registration component 121, passive recruiting information mediation component 122, target monitoring component 123, contact monitoring component 124 and alert generator component 125. In some embodiments, functions of electronic recruiting alert system 110 may be provided by a single component providing some or all functions of components 121-125. In some embodiments, components 121-125 may be arranged and configured according to any design configured to carry out the various aspects of this disclosure.

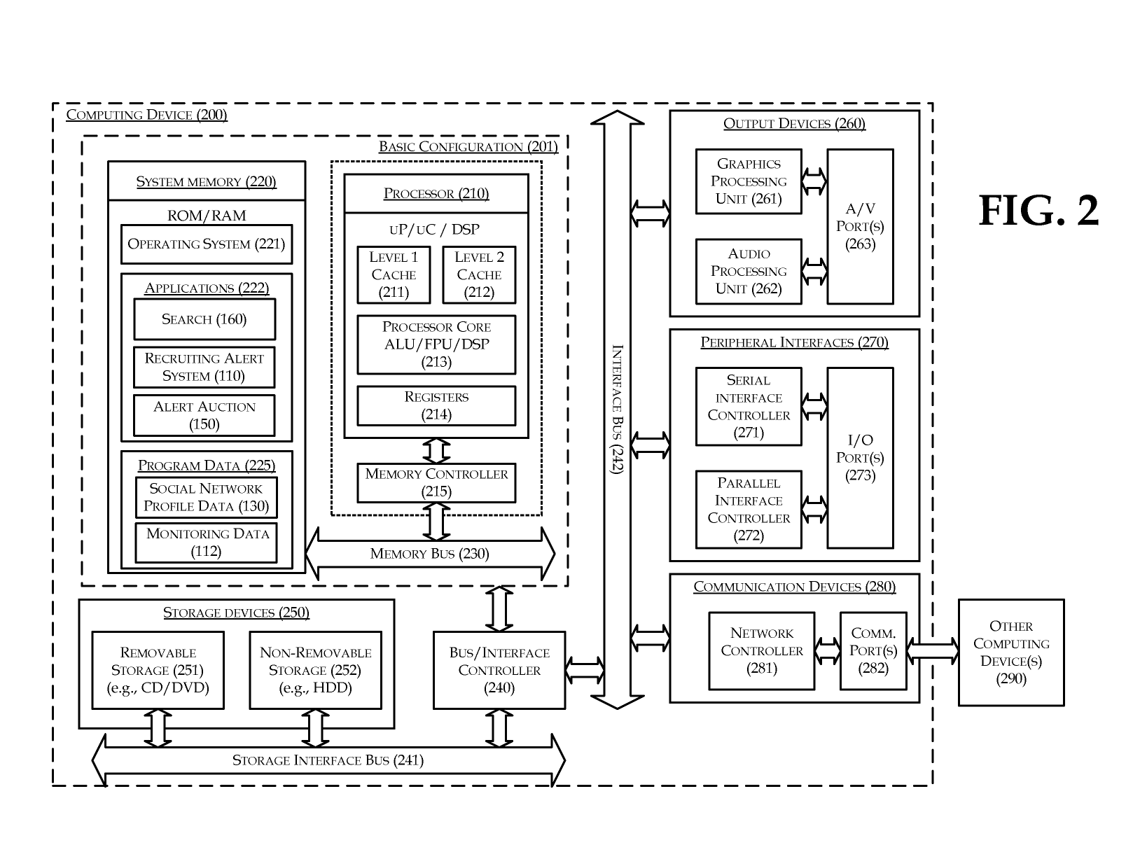

FIG. 2 is a block diagram of a computing device 200 as one example of a social network device 120, arranged in accordance with at least some embodiments of the present disclosure. In a very basic configuration 201, computing device 200 may include one or more processors 210 and system memory 220. A memory bus 230 may be used for communicating between the processor 210 and the system memory 220.

Depending on the desired configuration, processor 210 may be of any type including but not limited to a microprocessor (μP), a microcontroller (μC), a digital signal processor (DSP), or any combination thereof. Processor 210 may include one or more levels of caching, such as a level one cache 211 and a level two cache 212, a processor core 213, and registers 214. The processor core 213 may include an arithmetic logic unit (ALU), a floating point unit (FPU), a digital signal processing core (DSP Core), or any combination thereof. A memory controller 215 may also be used with the processor 210, or in some implementations the memory controller 215 may be an internal part of the processor 210.

Depending on the desired configuration, the system memory 220 may be of any type including but not limited to volatile memory (such as RAM), non-volatile memory (such as ROM, flash memory, etc.), or any combination thereof. System memory 220 typically includes an operating system 221, one or more applications 222, and program data 225. In some embodiments, operating system 221 may comprise a virtual machine that is managed by a Virtual Machine Manager (VMM). Applications 222 may include, for example, search component module(s) 160, recruiting alert system module(s) 110, and alert auction module(s) 150. Program data 225 may include social network profile data 130, monitoring data 112, and any other data that may be used by applications 160, 110, and 150, respectively.

Computing device 200 may have additional features or functionality, and additional interfaces to facilitate communications between the basic configuration 201 and any required devices and interfaces. For example, a bus/interface controller 240 may be used to facilitate communications between the basic configuration 201 and one or more data storage devices 250 via a storage interface bus 241. The data storage devices 250 may be removable storage devices 251, non-removable storage devices 252, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable and non-removable media implemented in any method or technology for storage of information, such as computer readable instructions, data structures, program modules, or other data.

Level 1 cache 211, level 2 cache 212, system memory 220, removable storage 251, and non-removable storage devices 252 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that may be used to store the desired information and that may be accessed by computing device 200. Any such computer storage media may be part of device 200.

Computing device 200 may also include an interface bus 242 for facilitating communication from various interface devices (e.g., output interfaces, peripheral interfaces, and communication interfaces) to the basic configuration 201 via the bus/interface controller 240. Example output devices 260 include a graphics processing unit 261 and an audio processing unit 262, which may be configured to communicate to various external devices such as a display or speakers via one or more A/V ports 263. Example peripheral interfaces 270 may include a serial interface controller 271 or a parallel interface controller 272, which may be configured to communicate through either wired or wireless connections with external devices such as input devices (e.g., keyboard, mouse, pen, voice input device, touch input device, etc.) or other peripheral devices (e.g., printer, scanner, etc.) via one or more I/O ports 273. Other conventional I/O devices may be connected as well such as a mouse, keyboard, and so forth. An example communications device 280 includes a network controller 281, which may be arranged to facilitate communications with one or more other computing devices 290 over a network communication via one or more communication ports 282.

The computer storage media may be one example of a communication media. Communication media may typically be embodied by computer readable instructions, data structures, program modules, or other data in a modulated data signal, such as a carrier wave or other transport mechanism, and include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR), and other wireless media.

Computing device 200 may be implemented as a server in a data center or portion of a data center supporting a social network. Computing device 200 may also be implemented as any other computing device operated by a social network provider in connection with providing recruiting alerts.

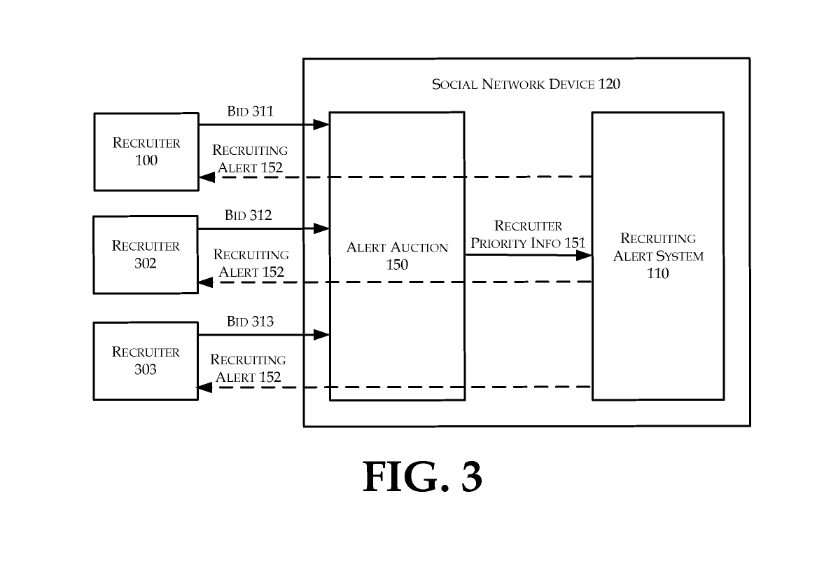

FIG. 3 is a block diagram illustrating an example social network device configured to provide recruiting alert auctions, arranged in accordance with at least some embodiments of the present disclosure. FIG. 3 includes recruiter 100, a recruiter 302, a recruiter 303, and social network device 120. Social network device 120 includes alert auction component 150 and recruiting alert system 110. Recruiters 100, 302, and 303 may be coupled to social network device 120 via a network such as the Internet. Social network device 120 may provide a website comprising UI accessible by recruiters 100, 302, and 303, and recruiters 100, 302, and 303 may access the website for example using any computing devices comprising browsers or other network communications technologies.

In FIG. 3, alert auction component 150 may be configured to provide UI implementing a recruiting alert auction, in which recruiters 100, 302, and 303 may bid for recruiting alert priority. Alert auction component 150 may be configured to establish via an online auction, one or more first priority recruiters from among recruiters 100, 302, and 303. Alert auction component 150 may be configured to provide recruiter priority information 151 identifying the first priority recruiter(s) to recruiting alert system 110. Recruiting alert system 110 may be configured to automatically provide recruiting alert 152 to recruiters 100, 302, and 303, in response to an event comprising a change in monitored social network profile data, wherein recruiting alert 152 is provided first to the first priority recruiter(s).

Recruiting alert system 110 may be configured to wait for at least a predetermined time interval, such as, for example, up to 4-5 weeks, after providing recruiting alert 152 to the first priority recruiter(s). For example, recruiting alert system 110 may be configured to start a timer configured to measure the predetermined time interval. After the predetermined time interval, recruiting alert system 110 may be configured to provide recruiting alert 152 to one or more second priority recruiters from among recruiters 100, 302, and 303, and/or to any other recruiters who may have registered for recruiting alerts.

In some embodiments, alert auction component 150 may be configured to receive bids 311, 312, 313, and to assign first priority to a highest bidding recruiter from among recruiters 100, 302, and 303, second priority to a second highest bidding recruiter from among recruiters 100, 302, and 303, and so on. Numerous other variations are possible. For example, in some embodiments only a first priority may be auctioned. The highest bidding recruiter may win first priority, and other recruiters may be provided recruiting alert 152 on a second-priority basis.

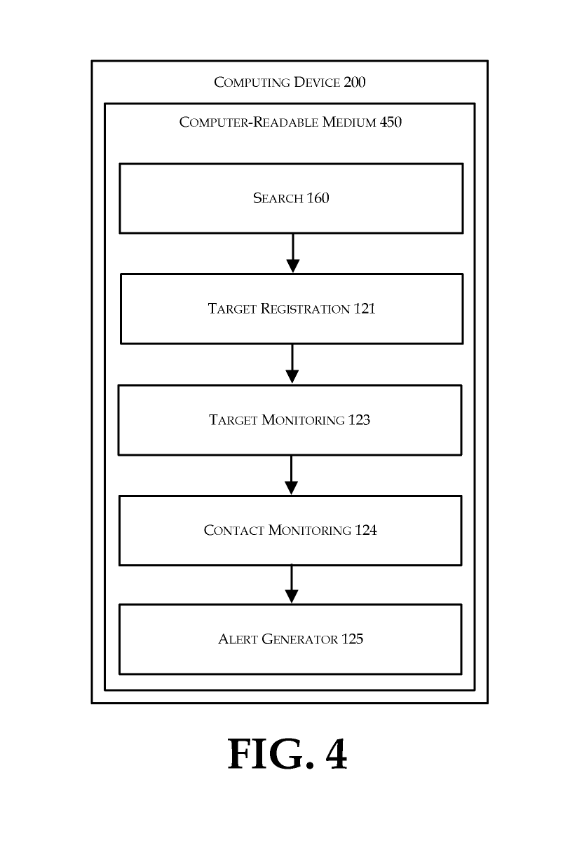

FIG. 4 is a flow diagram illustrating an example social network method configured to provide recruiting alerts, arranged in accordance with at least some embodiments of the present disclosure. The example flow diagram may include one or more operations/modules as illustrated by blocks 160, 121, 123, 124, and 125, which represent operations as may be performed in a method, functional modules in a computing device 200, and/or instructions as may be recorded on a computer readable medium 450. The illustrated blocks 160, 121, 123, 124, and 125 may be arranged to provide functional operations of “Search” at block 160, “Target Registration” at block 121, “Target Monitoring” at block 123, “Contact Monitoring” at block 124, and “Alert Generator” at block 125.

In FIG. 4, blocks 160, 121, 123, 124, and 125 are illustrated as being performed sequentially, e.g., with block 160 first and block 125 last. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

FIG. 4 illustrates an example method by which computing device 200 may support recruiter identification of passive recruiting targets through search 160, registration of passive recruiting targets for monitoring through target registration 121, monitoring of passive recruiting targets through target monitoring 123 and contact monitoring 124, and providing recruiting alerts to recruiters through alert generator 125.

In a “Search” block 160, computing device 200 may receive recruiter search parameters 101, and search social network profile data for profiles, e.g. among profile data 131-134, that match received search parameters. Matching profiles may be provided for review by recruiter 100. Computing device 200 may optionally receive selections from among the matching profiles. Computing device 200 may support registering passive recruiting targets identified in block 160 by providing target IDs, such as target ID 103, corresponding to recruiter selections, to block 121 for registration. Block 160 may be followed by block 121.

In a “Target Registration” block 121, computing device 200 may register the passive recruiting target in electronic recruiting alert system 110. Registration may comprise receiving and storing target ID 103. Registration may also optionally comprise receiving and storing monitoring data 112, and recruiter communication information 113. Computing device 200 may initiate block 123 to initiate monitoring of registered passive recruiting targets. Initiating block 123 may comprise, for example, providing target ID 103, monitoring data 112, and/or recruiter communication information 113 to block 123, or otherwise activating block 123 and providing block 123 with sufficient information to begin monitoring the passive recruiting target identified by target ID 103. Block 121 may followed by block 123.

In a “Target Monitoring” block 123, computing device 200 may electronically monitor social network profile data from 130 that is associated with the passive recruiting target. Computing device 200 may periodically search for data included in monitoring data 112. In some embodiments, computing device 200 may perform comparisons of social network profile data to previous social network profile data to detect changes therein. In some embodiments, computing device 200 may check any changes in social network profile data against monitoring data 112, to determine if a change is designated as a recruiting event in monitoring data 112. As stated above, example recruiting events include events comprising a threshold number of changes in the social network profile data associated with the passive recruiting target, each of the threshold number of changes occurring within a time window of predetermined length, events comprising a change of family status in the social network profile data associated with the passive recruiting target, and/or events comprising a change of address in the social network profile data associated with the passive recruiting target. Block 123 may be followed by block 124.

In a “Contact Monitoring” block 124, computing device 200 may identify set of contacts 126 linked to the passive recruiting target in social network graph 135, and to electronically monitor social network profile data associated with one or more contacts in set of contacts 126. Monitored contacts may include, for example, those having social network profile data indicating employment by a same employer as the passive recruiting target, and that are also directly linked to the passive recruiting target in the social network graph 135. In some embodiments, a recruiting event may comprise a change in employer information, address, job title, and/or social connection in social network profile data associated with one or more of the contacts in set of contacts 126. Block 124 may be followed by block 125.

In an “Alert Generator” block 125, computing device 200 may automatically generate recruiting alert 152 identifying the passive recruiting target in response to a recruiting event, such as a change in social network profile data associated with one or more of the contacts in the set of contacts and/or a change in social network profile data associated with the recruiting target. Changes comprising recruiting events may be specified in monitoring data 112. Computing device 200 may first provide recruiting alert 152 to a first priority recruiter, and second provide, after at least a predetermined time interval, recruiting alert 152 to a second priority recruiter, wherein the first priority recruiter is established via an online recruiting alert auction as described herein.

In addition to the various blocks of FIG. 4, social network methods configured to provide recruiting alerts may comprise providing passive recruiting information to the passive recruiting target via one or more communications channels within the social network corresponding to social network graph 135, that is, in contrast to communications via channels outside the supported social network. The provided passive recruiting information may comprise, e.g., a notification that the passive recruiting target has been identified as a recruiting target, and/or a notification that the passive recruiting target is being monitored by one or more recruiters. Methods may furthermore include receiving a passive recruiting target request for recruiter information, and mediating a communication between the passive recruiting target and recruiter in response to the passive recruiting target request.

FIG. 5 is a block diagram illustrating an example recruiter device configured to access social network recruiting alerts, arranged in accordance with at least some embodiments of the present disclosure. FIG. 5 includes social network device 120 and a recruiter device 500. Recruiter device 500 comprises a recruiter system 510 comprising a target registration component 501 and a target classification component 502. Social network device 120 comprises recruiting alert system 110.

In FIG. 5, target registration component 501 may be configured to receive data including one or more of target ID 103, monitoring data 112, and/or recruiter communication information 113. Target registration component 501 may be configured to register the passive recruiting target by providing target ID 103, monitoring data 112, and/or recruiter communication information 113 to recruiting alert system 110. Target registration component 501 may also be configured to provide passive recruiting information 505 to recruiting alert system 110. Target classification component 502 may be configured to receive a subsequent recruiting alert 152 and/or passive recruiting communication 105, and to classify the passive recruiting target as an active recruiting target in response to receiving recruiting alert 152 and/or passive recruiting communication 105.

In FIG. 5, recruiter device 500 may comprise one or more computing devices arranged similarly to computing devices according to FIG. 2, except that applications 222 for recruiter device 500 may omit search 160, recruiting alert system 110, and alert auction 150 as illustrated in FIG. 2, and program data 225 for recruiter device 500 may omit social network profile data 130 and monitoring data 112 as illustrated in FIG. 2. Instead, applications 222 for recruiter device 500 may include recruiter system 510 components such as target registration component 501 and target classification component 502, and program data 225 for recruiter device 500 may include target ID 103, monitoring data 112, and/or recruiter communication information 113, as well as target classification data. Social network device 120 may comprise for example a device according to FIG. 1 and/or FIG. 2.

In FIG. 5, recruiter device 500 may receive target ID 103, monitoring data 112, and/or recruiter communication information 113 from a human operator, and/or from another device. Recruiter device 500 may be coupled to social network device 120 via a network such as the Internet. Recruiter device 500 may be configured to interact with an API provided by social network device 120, to perform in automated fashion some or all of the various interactions between recruiter 100 and social network device 120 described in connection with FIG. 1. Recruiter system 510 may be configured as part of, or otherwise to interact with, human resource or other recruiter software that facilitates organizing and scheduling communications with recruiting targets, and which software may for example organize and schedule communications differently for passive versus active recruiting targets. In some embodiments, recruiter device 500 may operated by a recruiting services provider, which receives some or all of target ID 103, monitoring data 112, and/or recruiter communication information 113 from a third party recruiter device (not shown in FIG. 5), interacts with social network device 120 on behalf of the third party recruiter device, and provides recruiting alert information, optionally along with other recruiting information, to the third party recruiter device.

Target registration component 501 may be configured to receive data including an identification of one or more passive recruiting targets embodied by one or more target IDs such as target ID 103. Target registration component 501 may also be configured to receive monitoring data 112, and/or recruiter communication information 113. Target registration component 501 may be configured to receive recruiting data from a human operator, e.g., via registration UI configured to receive recruiting data. In some embodiments, target registration component 501 may be configured to store monitoring data 112 and recruiter communication information 113 so that such data is available for multiple registration operations and need not be re-entered. In some embodiments, target registration component 501 may be configured to receive and store target IDs such as target ID 103, e.g., from search component 160 as illustrated in FIG. 1, to allow later registration of received target IDs.

Target registration component 501 may be configured to register the passive recruiting target in a remote electronic recruiting alert system 110, wherein registering the passive recruiting target comprises sending information identifying the passive recruiting target, e.g., target ID 103, to a network interface provided by electronic recruiting alert system 110.

Target registration component 501 may also be configured to provide event monitoring data 112 to remote electronic recruiting alert system 110, wherein the event monitoring data 112 may for example specify monitoring of events comprising changes in social network profile data 130 associated with one or more contacts in a set of contacts linked to the passive recruiting target in a social network graph. Event monitoring data 112 provided by target registration component 501 may for example include data configured to specify that contact monitoring is desired. In some embodiments, event monitoring data 112 may include data configured to specify properties of contacts to be used by recruiting alert system 110 in determining which contacts to include in a monitored set of contacts, e.g., contacts that have social network profile data indicating employment by a same employer as the passive recruiting target, and/or contacts that are also directly linked to the passive recruiting target in the social network graph. Event monitoring data 112 may furthermore specify for example contacts that have social network profile data indicating a same position and/or same department as the passive recruiting target. In some embodiments, event monitoring data 112 may specify contacts that are directly linked to the passive recruiting target in the social network graph as well as a subset of contacts that are indirectly linked to the passive recruiting target, e.g., contacts that are 1, 2, and/or 3 steps away from the passive recruiting target in the social network graph.

In some embodiments, event monitoring data 112 may include data configured to specify which contact properties to monitor. For example, event monitoring data 112 may specify monitoring employer information in social network profile data associated with one or more contacts in the set of contacts linked to the passive recruiting target in the social network graph. Other properties may be specified in event monitoring data 112, such as contact recommendations, contact job title, contact address, and/or contact communications, including the presence of one or more specific words in communications between the passive recruiting target and his or her contacts.

In some embodiments, event monitoring data 112 may include data configured to specify social network profile data associated with the passive recruiting target for monitoring. Data associated with the passive recruiting target may include any social network profile data, for example any of monitoring data 112 discussed herein.

In some embodiments, target registration component 501 may be configured to provide passive recruiting information 505 to recruiting alert system 110. Passive recruiting information 505 may comprise information or settings configuring recruiting alert system 110 to handle passive recruiting information 128 and/or passive recruiting communications 129 and 105 (all illustrated in FIG. 1) according to recruiter preferences. For example, passive recruiting information 505 may comprise permissions allowing electronic recruiting alert system 110 to provide passive recruiting information 128 to the passive recruiting target.

Target classification component 502 may be configured to receive recruiting alert 152 identifying the passive recruiting target. Target classification component 502 may for example be configured to provide a network API that is accessible by recruiting alert system 110. Target classification component 502 may be configured to receive recruiting alert 152 via the network API. Target classification component 502 may be configured to reclassify the passive recruiting target identified in recruiting alert 152 as an active recruiting target in response to recruiting alert 152. Reclassification may for example comprise changing a database value from “passive” to “active”, sending reclassification information in the form of a notice, API call, or other communication to a third party recruiter device, or any other operation to effect a corresponding change in the manner in which recruiting is to be carried out.

Recruiting alert 152 may also optionally indicate that an event according to event monitoring data 112 occurred, and may include any level of detail regarding the recruiting event. For example, in some embodiments, recruiting alert 152 may identify the recruiting event, while in other embodiments, the recruiting event may not be identified, so that the recruiter only knows that some recruiting event occurred without necessarily knowing the nature of the recruiting event. In some embodiments, recruiting alert 152 may specify details such as an identification of a contact involved in the recruiting event, and/or specific data that triggered the recruiting event. In embodiments in which recruiting event details are provided, target classification component 502 may be configured to store received recruiting event details. However, in some embodiments recruiting alert system 110 may not provide recruiting event details beyond target IDs in recruiting alerts, to protect privacy of social network participants.

In some embodiments, target classification component 502 may be configured to receive passive recruiting communication 105. Target classification component 502 may be configured to reclassify the passive recruiting target as an active recruiting target in response to the passive recruiting communication 105. In some embodiments, target classification component 502 may be configured to store passive recruiting communication 105 for reference by recruiters when conducting recruiting activities directed to a reclassified recruiting target.

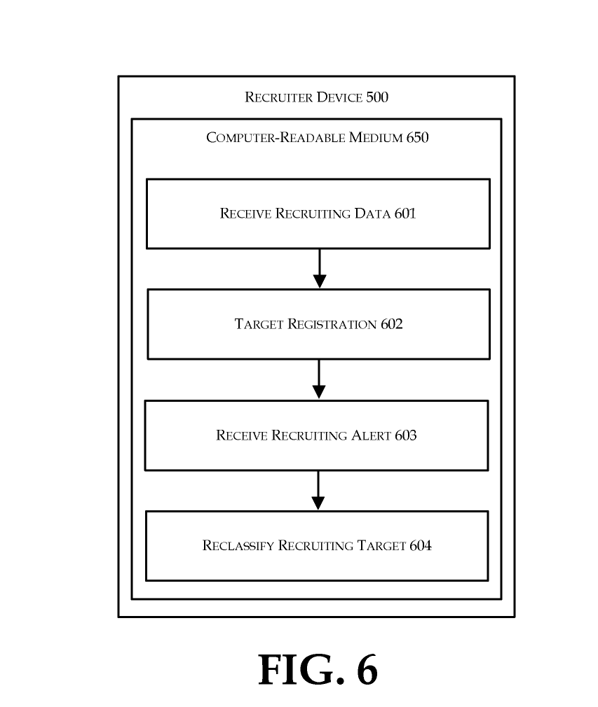

FIG. 6 is a flow diagram illustrating an example recruiter method for accessing social network recruiting alerts, arranged in accordance with at least some embodiments of the present disclosure. The example flow diagram may include one or more operations/modules as illustrated by blocks 601, 602, 603, and 604, which represent operations as may be performed in a method, functional modules in a recruiter device 500, and/or instructions as may be recorded on a computer readable medium 650. The illustrated blocks 601-604 may be arranged to provide functional operations of “Receive Recruiting Data” at block 601, “Target Registration” at block 602, “Receive Recruiting Alert” at block 603, and “Reclassify Recruiting Target” at block 604.

In FIG. 6, blocks 601-604 are illustrated as being performed sequentially, e.g., with block 601 first and block 604 last. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

FIG. 6 illustrates an example method by which recruiter device 500 may support automated recruiter interactions with a recruiting alert system 110 to register passive recruiting targets for monitoring in recruiting alert system 110, and to reclassify passive recruiting targets in response to recruiting alerts received from recruiting alert system 110.

In a “Receive Recruiting Data” block 601, recruiter device 500 may receive an identification of a passive recruiting target, e.g., from a human operator or from another computing device, as described herein. Monitoring data 112 and/or recruiter communication information 113 may also be received in block 601 as discussed herein. Block 601 may be followed by block 602.

In a “Target Registration” block 602, recruiter device 500 may register the passive recruiting target in a remote electronic recruiting alert system, such as recruiting alert system 110. Recruiter device 500 may register the passive recruiting target by sending information identifying the passive recruiting target to an electronic recruiting alert system network interface, or by another other technique for electronically communicating with recruiting alert system 110. In some embodiments, recruiter device 500 may also provide event monitoring data, such as monitoring data 112, to electronic recruiting alert system 110. Monitoring data 112 may be configured to specify monitoring of events comprising changes in social network profile data associated with one or more contacts in a set of contacts linked to the passive recruiting target in a social network graph, and/or any of the various other monitoring data 112 properties discussed herein. In some embodiments, recruiter device 500 may also provide passive recruiting information 505 to electronic recruiting alert system 110, e.g., permission allowing recruiting alert system 110 to provide passive recruiting information to the passive recruiting target, including for example a notification that the passive recruiting target is being monitored by the recruiter 100. Block 602 may be followed by block 603.

In a “Receive Recruiting Alert” block 602, recruiter device 500 may receive recruiting alert 152. Recruiter device 500 may for example provide a network API accessible by recruiting alert system 110, effective to configure recruiter device 500 to receive an automatically generated recruiting alert 152 from recruiting alert system 110. Recruiter device 500 may also receive additional information from recruiting alert system 110, e.g., passive recruiting communication 105. Block 603 may be followed by block 604.

In a “Reclassify Recruiting Target” block 604, recruiter device 500 may automatically reclassify the passive recruiting target as an active recruiting target in response to received recruiting alert 152. Recruiter device 500 may for example update recruiter data associated with the passive recruiting target. Recruiter device 500 may interact with human resource software or other recruiter software to effect a reclassification. Recruiter device 500 may also perform reclassification in other circumstances, e.g., in response to a reclassification command from a source other than recruiting alert system 110, such as from a human operator, and/or in response to receiving passive recruiting communication 105, such as a passive recruiting target request for information passed to recruiter device 500 via recruiting alert system 110.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely examples and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly inter-actable and/or wirelessly interacting components and/or logically interacting and/or logically inter-actable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While certain example techniques have been described and shown herein using various methods, devices and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

1. A social network method for providing a recruiting alert, comprising:
registering a passive recruiting target in an electronic recruiting alert system;
identifying, in the electronic recruiting alert system, a set of contacts linked to the passive recruiting target in a social network graph, wherein the set of contacts comprises contacts that have social network profile data indicating employment by a same employer as the passive recruiting target, and that are also directly linked to the passive recruiting target in the social network graph;
electronically monitoring, by the electronic recruiting alert system, employer information in social network profile data associated with contacts in the set of contacts; and
automatically generating, by the electronic recruiting alert system, a recruiting alert identifying the passive recruiting target in response to an event comprising a change in employer information in social network profile data associated with one or more of the contacts in the set of contacts, wherein the recruiting alert is effective to reclassify the passive recruiting target as an active recruiting target.

2-3. (canceled)

4. The method of claim 1, further comprising electronically monitoring, by the electronic recruiting alert system, social network profile data associated with the passive recruiting target, and automatically generating, by the electronic recruiting alert system, a recruiting alert identifying the passive recruiting target in response to one or more of:
an event comprising a threshold number of changes in the social network profile data associated with the passive recruiting target, each of the threshold number of changes occurring within a time window of predetermined length;
an event comprising a change of family status in the social network profile data associated with the passive recruiting target; and
an event comprising a change of address in the social network profile data associated with the passive recruiting target.

5. (canceled)

6. The method of claim 1, further comprising providing an electronic recruiting alert service to a third party, comprising:
receiving, at the electronic recruiting alert system, an identification of the passive recruiting target from a remote third-party computing device;
registering the passive recruiting target in the electronic recruiting alert system in response to said receiving; and
sending, by the electronic recruiting alert system, the recruiting alert identifying the passive recruiting target to the remote third-party computing device.

7. The method of claim 1, further comprising providing passive recruiting information to the passive recruiting target via a communications channel within a social network system corresponding to the social network graph, the passive recruiting information comprising a notification that the passive recruiting target is being monitored by one or more recruiters.

8. The method of claim 7, further comprising receiving a passive recruiting target request for recruiter information, and mediating a communication between the passive recruiting target and a recruiter in response to the passive recruiting target request.

9. The method of claim 1, further comprising first providing, by the electronic recruiting alert system, the recruiting alert to a first priority recruiter, and second providing, by the electronic recruiting alert system after at least a predetermined time interval, the recruiting alert to a second priority recruiter.

10. The method of claim 9, wherein the first priority recruiter is established via an online recruiting alert auction.

11. A non-transitory computer readable storage medium having computer executable instructions executable by a processor, the instructions that, when executed by the processor, implement an electronic recruiting alert system which causes the processor to:
register a passive recruiting target;
identify a set of contacts linked to the passive recruiting target in a social network graph, wherein the set of contacts comprises contacts that have social network profile data indicating employment by a same employer as the passive recruiting target, and that are also directly linked to the passive recruiting target in the social network graph;
electronically monitor employer information in social network profile data associated with contacts in the set of contacts; and
automatically generate a recruiting alert identifying the passive recruiting target in response to an event comprising a change in employer information in social network profile data associated with one or more of the contacts in the set of contacts, wherein the recruiting alert is effective to reclassify the passive recruiting target as an active recruiting target.

12-13. (canceled)

14. The non-transitory computer readable storage medium of claim 11, wherein the electronic recruiting alert system causes the processor to electronically monitor, by the electronic recruiting alert system, social network profile data associated with the passive recruiting target, and automatically generate, by the electronic recruiting alert system, a recruiting alert identifying the passive recruiting target in response to one or more of:
an event comprising a threshold number of changes in the social network profile data associated with the passive recruiting target, each of the threshold number of changes occurring within a time window of predetermined length;
an event comprising a change of family status in the social network profile data associated with the passive recruiting target; and
an event comprising a change of address in the social network profile data associated with the passive recruiting target.

15. (canceled)

16. The non-transitory computer readable storage medium of claim 11, wherein the electronic recruiting alert system causes the processor to provide an electronic recruiting alert service to a third party, comprising instructions that cause the processor to:
receive, at the electronic recruiting alert system, an identification of the passive recruiting target from a remote third-party computing device;
register the passive recruiting target in the electronic recruiting alert system in response to receiving the identification of the passive recruiting target; and
send, by the electronic recruiting alert system, the recruiting alert identifying the passive recruiting target to the remote third-party computing device.

17. The non-transitory computer readable storage medium of claim 11, wherein the electronic recruiting alert system causes the processor to provide passive recruiting information to the passive recruiting target via a communications channel within a social network system corresponding to the social network graph, the passive recruiting information comprising a notification that the passive recruiting target is being monitored by one or more recruiters.

18. The non-transitory computer readable storage medium of claim 17, wherein the electronic recruiting alert system causes the processor to receive a passive recruiting target request for recruiter information, and mediate a communication between the passive recruiting target and a recruiter in response to the passive recruiting target request.

19. The non-transitory computer readable storage medium of claim 11, wherein the electronic recruiting alert system causes the processor to first provide the recruiting alert to a first priority recruiter, and second provide, after at least a predetermined time interval, the recruiting alert to a second priority recruiter.

20. The non-transitory computer readable storage medium of claim 19, wherein the first priority recruiter is established via an online recruiting alert auction.

21. A computing device configured to provide an electronic recruiting alert system, comprising:
a processor;
a memory; and
an electronic recruiting alert system stored in the memory and executable by the processor, wherein the electronic recruiting alert system is configured to:
register a passive recruiting target;
identify a set of contacts linked to the passive recruiting target in a social network graph, wherein the set of contacts comprises contacts that have social network profile data indicating employment by a same employer as the passive recruiting target, and that are also directly linked to the passive recruiting target in the social network graph;
electronically monitor employer information in social network profile data associated with contacts in the set of contacts; and
automatically generate a recruiting alert identifying the passive recruiting target in response to an event comprising a change in employer information in social network profile data associated with one or more of the contacts in the set of contacts, wherein the recruiting alert is effective to reclassify the passive recruiting target as an active recruiting target.

22-23. (canceled)

24. The computing device of claim 21, wherein the electronic recruiting alert system is configured to electronically monitor, by the electronic recruiting alert system, social network profile data associated with the passive recruiting target, and automatically generate, by the electronic recruiting alert system, a recruiting alert identifying the passive recruiting target in response to one or more of:
an event comprising a threshold number of changes in the social network profile data associated with the passive recruiting target, each of the threshold number of changes occurring within a time window of predetermined length;
an event comprising a change of family status in the social network profile data associated with the passive recruiting target; and
an event comprising a change of address in the social network profile data associated with the passive recruiting target.

25. (canceled)

26. The computing device of claim 21, wherein the electronic recruiting alert system is configured to provide an electronic recruiting alert service to a third party, wherein the recruiting alert service is configured to:
receive an identification of the passive recruiting target from a remote third-party computing device;
register the passive recruiting target in response to receiving the identification of the passive recruiting target; and
send the recruiting alert identifying the passive recruiting target to the remote third-party computing device.

27. The computing device of claim 21, wherein the electronic recruiting alert system is configured to provide passive recruiting information to the passive recruiting target via a communications channel within a social network system corresponding to the social network graph, the passive recruiting information comprising a notification that the passive recruiting target is being monitored by one or more recruiters.

28. The computing device of claim 27, wherein the electronic recruiting alert system is configured to receive a passive recruiting target request for recruiter information, and mediate a communication between the passive recruiting target and a recruiter in response to the passive recruiting target request.

29. The computing device of claim 21, wherein the electronic recruiting alert system is configured to first provide the recruiting alert to a first priority recruiter, and second provide, after at least a predetermined time interval, the recruiting alert to a second priority recruiter.

30. The computing device of claim 29, wherein the first priority recruiter is established via an online recruiting alert auction.

31-63. (canceled)
